(19) United States
(12) Patent Application Publication
(10) Pub. No.: US 2016/0343251 A1
(43) Pub. Date: Nov. 24, 2016

(54) SMART VEHICLE CHECKING SYSTEM FOR COUNTERTERRORISM

(71) Applicant: HIZEN CO.,LTD, Daejeon (KR)

(72) Inventor: Myeiong-Sik LEE, Daejeon (KR)

(73) Assignee: HIZEN CO., LTD, Daejeon (KR)

(21) Appl. No.: 14/650,566

(22) PCT Filed: Apr. 29, 2015
(86) PCT No.: PCT/KR2015/004310

§ 371 Date: Jun. 8, 2015

(30) Foreign Application Priority Data
Dec. 9, 2014 (KR) 10-2014-0175901

(51) Int. Cl. G08G 1/017; G06K 9/00; G06K 9/32; E01F 13/04; E01F 15/00; E01F 15/14; E01F 13/10; G08G 1/04; E01F 13/12

(52) U.S. Cl. CPC G08G 1/0175; G08G 1/04; G06K 9/00771; G06K 9/3258; G06K 9/00604; G06K 9/00033; E01F 13/123; E01F 13/126; E01F 15/003; E01F 15/14; E01F 13/10; E01F 13/04; G06K 2209/15

(57) ABSTRACT

Disclosed is a smart vehicle checking system for counterterrorism which may move to be installed in a desired place, identify a vehicle license number and occupants in a vehicle, inspect the bottom surface of the vehicle as well as the inside of the vehicle to check explosives in the vehicle or the number of the occupants in the vehicle, and prevent escape of the vehicle and recognize a vehicle escape route in real time during an emergency.

### TECHNICAL FIELD

The present invention relates to a smart vehicle checking system for counterterrorism which may move to be installed in a desired place, identify a vehicle license number and occupants in a vehicle, inspect the bottom surface of the vehicle as well as the inside of the vehicle to check explosives in the vehicle and the number of the occupants in the vehicle, and prevent escape of the vehicle and recognize a vehicle escape route in real time during an emergency.

### BACKGROUND ART

In general, at a checkpoint, in order to arrest a suspect through questioning, inspectors perform inspection only through barricades for controlling vehicles and thus, there is no apparatus assisting an inspector to rapidly cope with an escaping vehicle.

Further, while an inspector actively executes his/her duties, a life threatening event may occur, causing physical and mental burdens and physical danger of the inspector.

In order to arrest a suspect, to control a drunk driver, to arrest a wanted vehicle or to search for illegal explosives, questioning and search of vehicles are generally frequently carried out regardless of places.

Unpredictable situations in which a suspect, a drunk driver, or a driver of a wanted vehicle or a vehicle loaded with illegal explosives does not respond to questioning and search by an inspector and escapes using a vehicle to be inspected frequently occur.

However, there is no apparatus which may assist an inspector to rapidly control an escaping vehicle to be questioned and thus, a case that the inspector fails to arrest an escaping vehicle frequently occurs and the inspector may be injured during a process of obstructing the escaping vehicle.

Further, recently, after the September 11 attacks in U.S., car bombings by terrorists are rapidly increased and the terrorism aspect is changed from terror attacks on a specific country or main public offices, such as military bases and police stations, to random terror attacks targeting many unspecified persons.

Therefore, respective countries desire to be prepared for terror attacks and to completely check and search vehicles which could be used in terrorism.

Korean Patent Laid-open Publication No. 2006-0101153 discloses a vehicle check/search and escape prevention device as a device for checking vehicles.

Such a conventional device momentarily damages tires of a vehicle and thus causes a driver of the vehicle to temporarily lose steering capability.

Therefore, a person needs to directly check a license plate of a vehicle, identify occupants in the vehicle and search for explosives in the vehicle.

### DISCLOSURE

### Technical Problem

Therefore, the present invention has been made in view of the above problems, and it is an object of the present invention to provide a smart vehicle checking system for counterterrorism which may identify a vehicle license number and occupants in a vehicle, inspect the bottom surface of the vehicle as well as the inside of the vehicle to check explosives in the vehicle or the number of the occupants in the vehicle, and prevent escape of the vehicle and recognize a vehicle escape route in real time during an emergency.

It is another object of the present invention to provide a smart vehicle checking system for counterterrorism which may be foldable and thus be installed in a desired place.

### Technical Solution

In accordance with an aspect of the present invention, the above and other objects can be accomplished by the provision of a smart vehicle checking system for counterterrorism including a base having a vehicle entrance base and a vehicle exit base, connected thereto, a plurality of bollards installed on the vehicle entrance base and the vehicle exit base so as to be raised and lowered, vehicle inside inspection units installed at both sides of the base so as to see through the inside of a vehicle entering the base, an identification unit installed at the right edge of the base so as to identify a driver of the vehicle, a vehicle escape prevention unit installed on the bottom surface of the base to idle respective wheels of the vehicle to prevent escape of the vehicle, an image acquisition unit installed on the bottom surface of the base and moving to photograph the lower portion of the vehicle, and an unevenness unit installed within the vehicle exit base and selectively protruding.

The vehicle entrance base and the vehicle exit base may be foldable upwards so that the base is movable.

A pair of bollards spaced from each other by a designated interval may be installed on each of the vehicle entrance base and the vehicle exit base and a laser irradiation unit may be combined with one of the pair of bollards installed on the vehicle entrance base to irradiate laser beams recognizable by the vehicle driver between the pair of bollards installed on the vehicle entrance base.

An elevating lift configured to raise the front portion of the stopped vehicle so as to prevent escape of the vehicle may be installed on the base.

The identification unit may include a housing having an iris recognizer and a fingerprint recognizer installed thereon, a controller installed within the housing, and a speaker installed within the housing and supporting voice.

A license plate recognition unit to recognize the license plate of the vehicle may be installed on the upper surface of the housing.

The identification unit may further include a wireless communication unit configured to perform signal transmission/reception with a server having information of wanted vehicles and wanted vehicle drivers stored therein and a control center.

The vehicle inside inspection unit may include an X-ray scanner.

The vehicle escape prevention unit may be configured such that two pairs of rollers corresponding to front wheels and rear wheels of the vehicle are exposed from the upper surface of the base and a brake to selectively prevent free rotation of each of the rollers may be installed on each of the rollers.

The image acquisition unit may include a CCTV configured to be automatically transferred on the upper surface of the base and moving to photograph the lower surface of the vehicle.

A plurality of through holes may be formed through the vehicle exit base, and the unevenness unit may include a plate, one side of which is hinged to the inside of the vehicle exit base, a plurality of iron pins protruding from the surface of the plate, and an elevating cylinder to raise the plate so that the iron pins protrude from the through holes.

A GPS monitoring unit raised to attach a GPS transmitter to the lower surface of the vehicle may be further installed on the base.

The smart vehicle checking system for counterterrorism may further include protection walls hinged to both side surfaces of the base.

The smart vehicle checking system for counterterrorism may further include a proximity sensor configured to detect a distance from the vehicle.

### Advantageous Effects

In a smart vehicle checking system for counterterrorism in accordance with the present invention, since respective elements may be separated from a base and the base is foldable, the smart vehicle checking system for counterterrorism may be loaded on a large vehicle and move to be installed in a desired place.

Further, the smart vehicle checking system for counterterrorism may attach a GPS transmitter to a vehicle during an emergency and, thus, track the moving path of the vehicle in real time and detect a place of residence of a wanted person.

Further, the smart vehicle checking system for counterterrorism may identify a vehicle license number and occupants in a vehicle and inspect the bottom surface of the vehicle as well as the inside of the vehicle to check explosives in the vehicle and the number of the occupants in the vehicle, thus preventing accidents.

Moreover, the smart vehicle checking system for counterterrorism may prevent escape of the vehicle through protruding iron pins, bollards and an elevating lift.

### DESCRIPTION OF DRAWINGS

The above and other objects, features and other advantages of the present invention will be more clearly understood from the following detailed description taken in conjunction with the accompanying drawings, in which:

FIG. 1 is a view illustrating a configuration of a smart vehicle checking system for counterterrorism in accordance with the present invention;

FIG. 2 is a cross-sectional view of a base of FIG. 1;

FIG. 3 is a side view of the base in a folded state in accordance with the present invention;

FIG. 4 is a perspective view of an identification unit of FIG. 1;

FIG. 5 is a block diagram of the smart vehicle checking system for counterterrorism in accordance with the present invention;

FIG. 6 is a conceptual view illustrating the smart vehicle checking system for counterterrorism in accordance with the present invention in use;

FIG. 7 is a view illustrating a configuration of a smart vehicle checking system for counterterrorism in accordance with another embodiment of the present invention; and

FIG. 8 is a perspective view illustrating protection walls in an upright state of FIG. 7.

### BEST MODE

Hereinafter, a smart vehicle checking system for counterterrorism in accordance with the present invention will be described in detail with reference to the accompanying drawings.

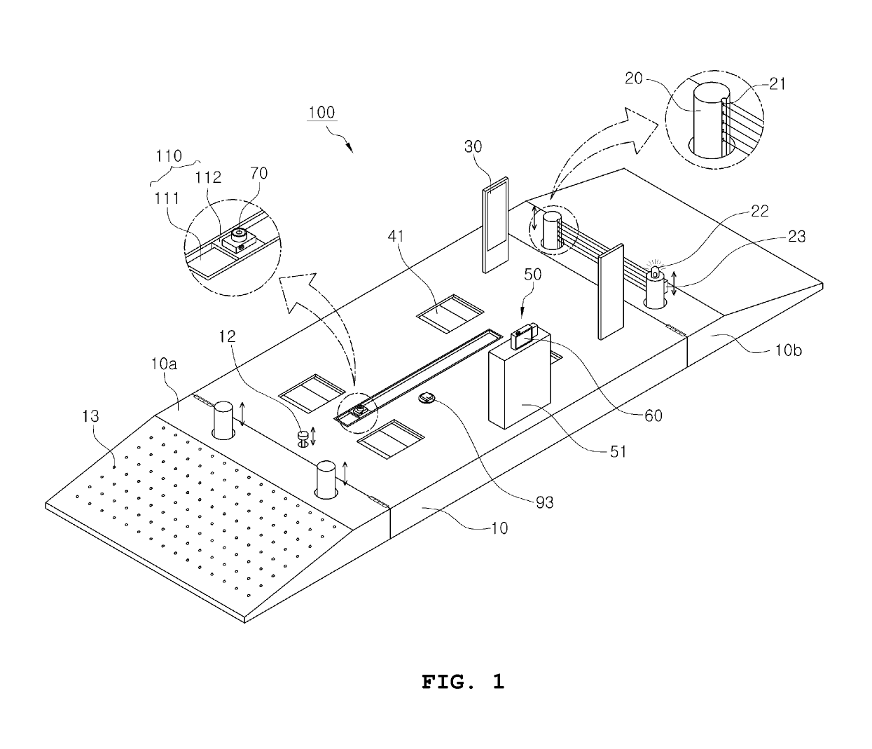

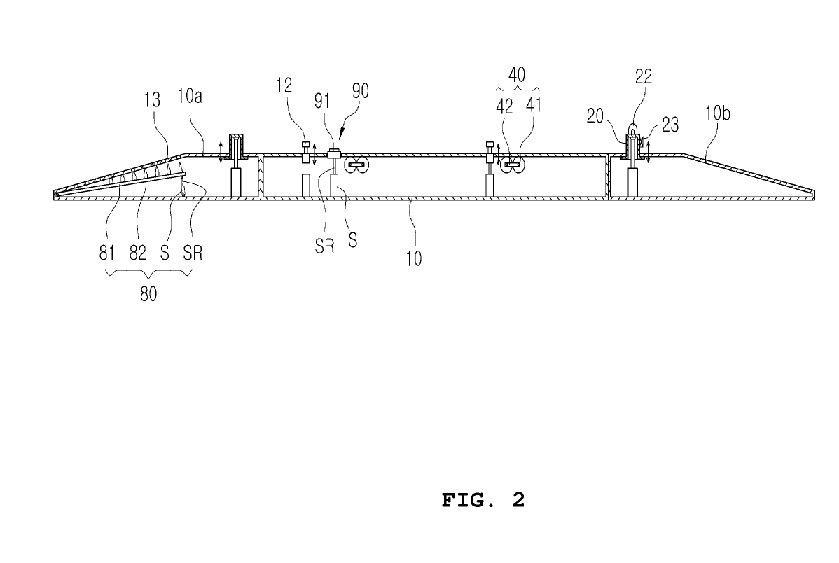

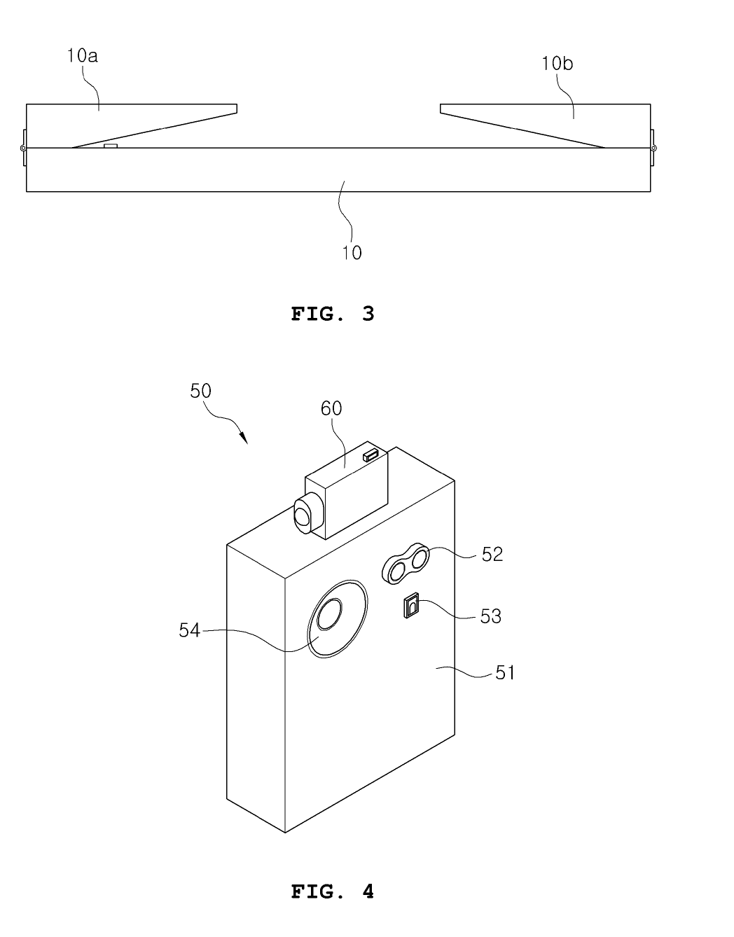

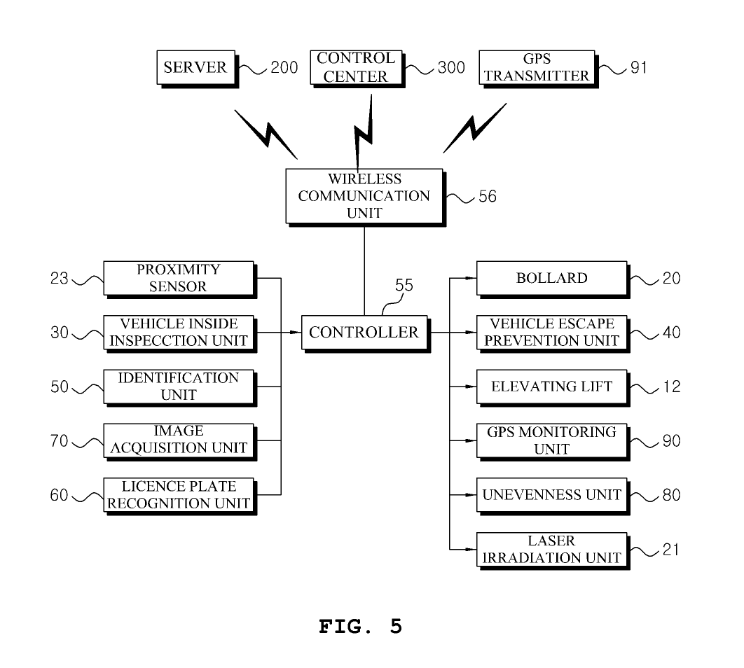

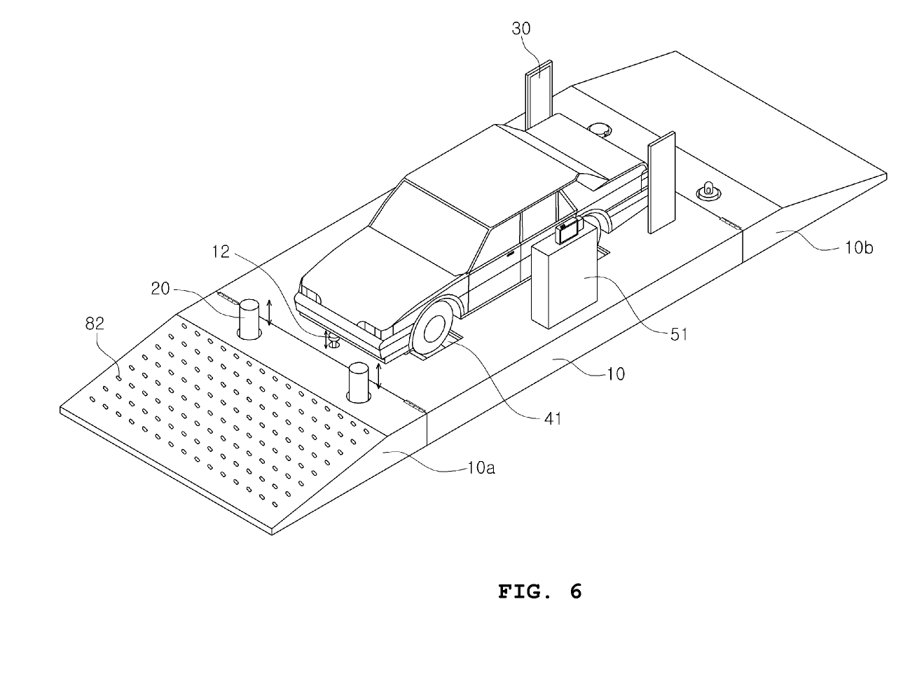

FIG. 1 is a view illustrating a configuration of a smart vehicle checking system for counterterrorism in accordance with the present invention, FIG. 2 is a cross-sectional view of a base of FIG. 1, FIG. 3 is a side view of the base in a folded state in accordance with the present invention, FIG. 4 is a perspective view of an identification unit of FIG. 1, FIG. 5 is a block diagram of the smart vehicle checking system for counterterrorism in accordance with the present invention, and FIG. 6 is a conceptual view illustrating the smart vehicle checking system for counterterrorism in accordance with the present invention in use.

As exemplarily shown in FIGS. 1 to 6, the present invention relates to a smart vehicle checking system for counterterrorism 100 which may move to be installed in a desired place, identify a vehicle license number and occupants in a vehicle, inspect the bottom surface of the vehicle as well as the inside of the vehicle to check explosives in the vehicle or the number of the occupants in the vehicle, and prevent escape of the vehicle and recognize a vehicle escape route in real time during an emergency.

Such a smart vehicle checking system for counterterrorism 100 includes a base 10, bollards 20 installed on the base 10, vehicle inside inspection units 30, an identification unit 50, a vehicle escape prevention unit 40, an image acquisition unit 70, and an unevenness unit 80.

The base 10 has a width corresponding to the size of a traffic lane of a road so that a vehicle may enter the base 10.

Such a base 10 is configured such that a vehicle entrance base 10b and a vehicle exit base 10a are hinged to the base 10 and are foldable to be loaded on a large vehicle.

Here, the thickness of the vehicle entrance base 10b and the vehicle exit base 10a is gradually decreased so that a vehicle may easily enter the vehicle entrance base 10b and exit from the vehicle exit base 10a, and the vehicle entrance base 10b and the vehicle exit base 10a are folded toward the base 10 by two steps.

A plurality of through holes 13 is formed through the vehicle exit base 10a and the unevenness unit 80 selectively protruding from the through holes 13 is installed within the vehicle exit base 10a.

In the unevenness unit 80, iron pins 82 selectively protrude from the through holes 13 and may thus damage tires of a vehicle which is separated from the base 10 and thus escapes.

For this purpose, the unevenness unit 80 includes a plate 81, one side of which is hinged to the inside of the vehicle exit base 10a, a plurality of iron pins 82 protruding from the surface of the plate 81, an elevating cylinder S to raise the plate 81 so that the iron pins 82 protrude from the through holes 13 of the vehicle exit base 10a, and a rod SR extracted from the elevating cylinder S.

A pair of bollards 20 separated from each other by a designated interval is installed on each of the vehicle entrance base 10b and the vehicle exit base 10a of the base 10 to be raised and lowered as needed and serves to reduce the velocity of a vehicle or to stop the vehicle on the base 10.

Here, a laser irradiation unit 21 to irradiate laser beams recognizable by a vehicle driver between the bollards 20 installed on the vehicle entrance base 10b is installed on one of the bollards 20 installed on the vehicle entrance base 10b, thus causing the vehicle driver to reduce a vehicle velocity.

Further, a warning light 22 may be combined with the other of the bollards 20 installed on the vehicle entrance base 10b, thus being used in combination with the laser irradiation unit 22.

Further, the smart vehicle checking system for counterterrorism 100 in accordance with the present invention may further include a proximity sensor 23 to detect a distance from a vehicle.

Such a proximity sensor 23 may be installed on one selected from the base 10, the bollards 20, the vehicle entrance base 10b, the vehicle exit base 10a, the vehicle inside inspection units 30, and a housing 51 of the identification unit 50.

In one embodiment of the present invention, the proximity sensor 23 may be installed on one bollard 20 selected from the bollards 20 so as to exclude interference of an obstacle during sensing of a distance from a vehicle.

Such a proximity sensor 23 allows the bollards 20 to be automatically lowered, when a vehicle approaches the vehicle entrance base 10b, so that the vehicle may enter the base 10.

Further, the smart vehicle checking system for counterterrorism 100 in accordance with the present invention may further include a velocity senor (not shown) to sense the velocity of a vehicle, thus being capable of sensing the velocity of the vehicle.

Such a velocity sensor (not shown) may be installed on one selected from the base 10, the bollards 20, the vehicle entrance base 10b, the vehicle exit base 10a, the vehicle inside inspection units 30, and the housing 51 of the identification unit 50.

Thereby, a controller 55 may judge a distance from a vehicle, measured by the proximity sensor 23, and a regulated velocity of the vehicle, sensed by the velocity sensor (not shown), and thus determine whether to raise and lower the bollards 20.

The vehicle inside inspection units 30 are installed at the left and right sides of the base 10 so as to see through the inside of a vehicle entering the base 10.

The vehicle inside inspection unit 30 may include an X-ray scanner serving to detect dangerous articles loaded in the vehicle or the number of persons in the vehicle.

Further, the identification unit 50 may be detachably fixed to the right edge of the base 10 (a region close to a driver's seat of a vehicle) so as to identify a driver of a vehicle entering the base 10.

Such an identification unit 50 includes the housing 51 provided with an iris recognizer 52 and a fingerprint recognizer 53 installed thereon, the controller 55 installed within the housing 51, and a speaker 54 installed within the housing 51 and supporting voice.

That is, in the identification unit 50, the speaker 54 may output voice guidance to identify a driver of a vehicle, and the driver may put his/her eyes into contact with the iris recognizer 52 or his/her finger into contact with the fingerprint recognizer 53 according to the voice guidance and thus be identified.

Further, the identification unit 50 may further include a wireless communication unit 56 within the housing 51 so as to perform signal transmission/reception with a server 200 in which information of wanted vehicles and wanted vehicle drivers is stored and a control center 300.

Thereby, if a driver of a vehicle is wanted, the controller 55 automatically controls the bollards 20, the vehicle escape prevention unit 40, an elevating lift 12 and a GPS monitoring unit 90.

Further, a license plate recognition unit 60 to recognize the license plate of a vehicle is further installed on the upper surface of the housing 51.

Such a license plate recognition unit 60 may employ various known methods and, for example, use a brightness variation between characters and a background of the license plate region of a vehicle.

Using the fact that the brightness value of a number or a character part has a continuous brightness variation vector from a negative value to a positive value or from a positive value to a negative value, it may be estimated that a license plate region is located at a position where brightness is symmetrically changed and a character or a number may be judged by expanding a target region from the estimated coordinates.

Information acquired by the license plate recognition unit 60 may be transmitted directly to the control center 300 or be used for the controller 55 to automatically judge a wanted vehicle by receiving information from the server 200 through the wireless communication unit 56.

Further, the vehicle escape prevention unit 40 is installed on the bottom surface of the base 10 and serves to idle respective wheels of a vehicle so as to prevent escape of the vehicle.

The vehicle escape prevention unit 40 is configured such that two pairs of rollers 41 corresponding to front wheels and rear wheels of the vehicle are exposed from the upper surface of the base 10. Here, a brake 42 to selectively prevent free rotation of each of the rollers 41 is installed on each of the rollers 41.

When four wheels of a vehicle are seated on the respective rollers 41, restriction of the brakes 42 is released so that the vehicle is not separated from the rollers 41 and, if a driver of the vehicle is identified or information of the vehicle is confirmed, the controller 55 controls the brakes 42 so as to restrict rotation of the respective rollers 41 so that the vehicle may advance.

Further, the image acquisition unit 70 serves to photograph the lower portion of a vehicle and may include a CCTV which is automatically transferred on the upper surface of the base 10 so as to acquire the image of the lower portion of the vehicle.

The image acquisition unit 70 may be detachably connected to a linear motor 110. Here, the image acquisition unit 70 is detachably installed on a mover 112 transferred along a stator 111 installed on the upper surface of the base 10.

In addition, the vehicle inside inspection unit 30 may include a combination of a chain, a ball screw or a belt connected to a driving unit.

The elevating lift 12 to raise the front portion of a stopped vehicle so as to prevent escape of the vehicle may be installed on the base 10.

Such an elevating lift 12 serves to prevent escape of the vehicle according to vehicle information or identification information of the vehicle driver, when the elevating lift 12 is controlled by the controller 55.

Further, the GPS monitoring unit 90 may be further installed on the base 10 so as to attach a GPS transmitter 91 to the lower surface of the vehicle.

The GPS monitoring unit 90 is configured such that the GPS transmitter 91 is seated on a rod SR of a elevating cylinder S and may be attached to the lower portion of the vehicle by magnetic force according to raise of the rod SR.

Thereby, if a wanted vehicle or a wanted driver is identified, the GPS monitoring unit 90 may pass the vehicle and monitor the moving route of the vehicle through the GPS.

Hereinafter, operation of the smart vehicle checking system for counterterrorism 100 in accordance with the present invention will be described in brief.

The controller 55 and the control center 300 receive vehicle information, vehicle driver information and dangerous article image information through the proximity sensor 23, the vehicle inside inspection units 30, the identification unit 50, the image acquisition unit 70 and the license plate recognition unit 60.

Then, the controller 55 may automatically control the bollards 20, the vehicle escape prevention unit 40, the elevating lift 12 and the GPS monitoring unit 90 or the control center 300 may manually control the same according to input information.

Further, the smart vehicle checking system for counterterrorism 100 in accordance with the present invention may be installed in connection with barricades along traffic lanes of a road.

The warning light 22 and the laser irradiation unit 21 to irradiate layer beams recognizable by a vehicle driver may be installed on the bollards 20 installed on the vehicle entrance base 10b of the base 10 and thus reduce the velocity of a driving vehicle.

When the velocity of the vehicle is reduced and the vehicle approaches the vehicle entrance base 10b, the proximity sensor 23 detects a distance from the vehicle and lowers the bollards 20 installed on the vehicle entrance base 10b to guide the vehicle to the base 10.

When the vehicle enters the base 10, the X-ray scanner of the vehicle inside inspection unit 30 detects dangerous articles loaded in the vehicle or the number or persons in the vehicle.

Simultaneously, the license plate recognition unit 60 recognizes the license plate of the vehicle and thus detects whether or not the vehicle is wanted.

Thereafter, when four wheels of the vehicle are seated on the respective rollers 41 of the vehicle escape prevention unit 40, the bollards 20 installed on the vehicle exit base 10a and the vehicle entrance base 10b and the unevenness unit 80 are automatically raised by the controller 55.

Here, although the wheels of the vehicle are rotated under the condition that the brakes 42 of the respective rollers 41 are released, the respective rollers 41 of the vehicle escape prevention unit 40 may prevent escape of the vehicle due to free rotation of the respective rollers 41.

Simultaneously, the CCTV of the image acquisition unit 70 acquires the image of the lower portion of the stopped vehicle.

If dangerous articles in the vehicle are found or if the vehicle is wanted, the controller 55 raises the elevating lift 12 so as to lift and fix the front portion of the vehicle and then calls a guard through the control center 300 to directly question passengers in the vehicle.

On the other hand, if no dangerous article is found in the vehicle or if the vehicle is not wanted, the speaker 54 of the identification unit 50 outputs voice guidance and the driver of the vehicle puts his/her eyes into contact with the iris recognizer 52 or his/her finger into contact with the fingerprint recognizer 53 according to the voice guidance and thus be identified.

When identification of the driver of the vehicle has been completed, the controller 55 restricts the respective rollers 41 of the vehicle runaway prevention unit 40 through the brakes 42 and lowers the bollards 20 and the unevenness unit 80 installed on the vehicle exit base 10a so that the vehicle passes through the vehicle exit base 10a.

Further, if the vehicle is wanted or if the driver of the vehicle is wanted, the smart vehicle checking system for counterterrorism 100 may pass the vehicle under the condition that the controller 55 or the control center 300 operates the GPS monitoring unit 90 to attach the GPS transmitter 91 to the lower surface of the vehicle and, then, the moving path of the vehicle may be monitored in real time through the GPS.

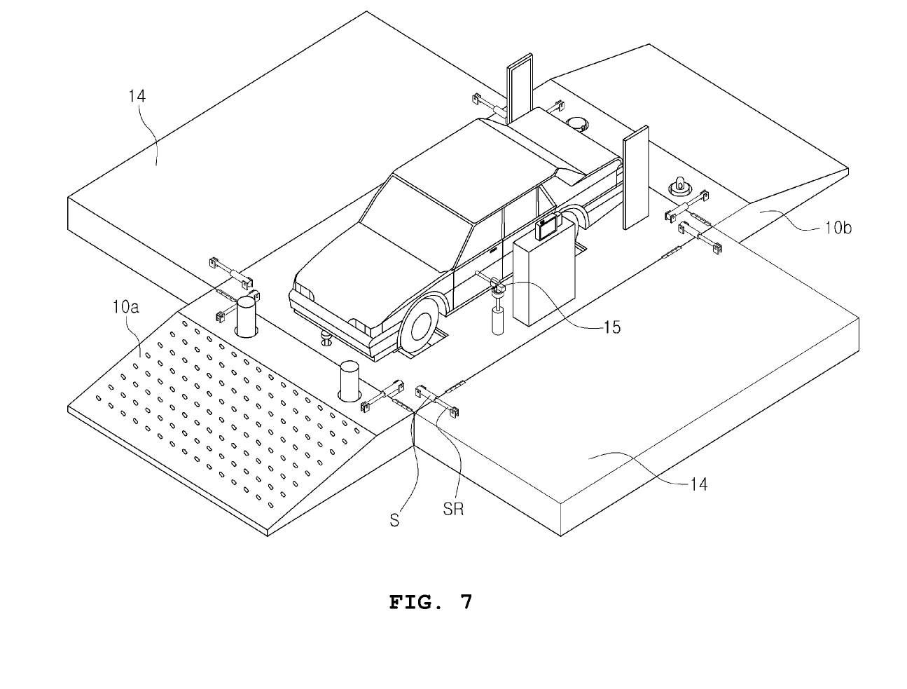

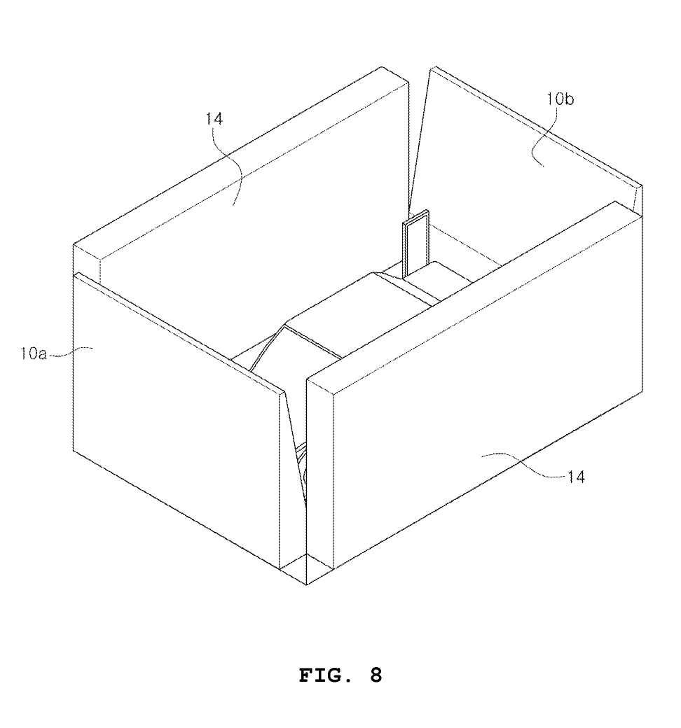

FIG. 7 is a view illustrating a configuration of a smart vehicle checking system for counterterrorism in accordance with another embodiment of the present invention and FIG. 8 is a perspective view illustrating protection walls in an upright state of FIG. 7.

As exemplarily shown in FIGS. 7 and 8, protection walls 14 may be additionally hinged to both side surfaces, i.e., left and right surfaces, of a base 10.

The protection walls 14 may be combined with rods SR of cylinders S fixed to the base 10.

Therefore, if an image acquisition unit 70 and vehicle inside inspection units 30 find explosives from the inside or outside of a vehicle, a controller 55 may extend or retract the rod SR of the cylinder S to erect the protection walls 14.

Further, a vehicle entrance base 10b and a vehicle exit base 10a may also be combined with rods SR of cylinders S fixed to the base 10 so as to be erected at one end and the other end of the base 10.

Therefore, although the vehicle explodes, scattering of fragments of explosives or fragments of the vehicle to the outside may be prevented and, thus, human life may be protected.

Of course, an unmanned automation device 15 to provide a warning to passengers of the vehicle may be installed on the upper surface of the base 10.

### MODE FOR INVENTION

Various embodiments have been described in the best mode for carrying out the invention.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A smart vehicle checking system for counterterrorism comprising:
a base having a vehicle entrance base and a vehicle exit base, connected thereto;
a plurality of bollards installed on the vehicle entrance base and the vehicle exit base so as to be raised and lowered;
vehicle inside inspection units installed at both sides of the base so as to see through the inside of a vehicle entering the base;
an identification unit installed at the right edge of the base so as to identify a driver of the vehicle;
a vehicle escape prevention unit installed on the bottom surface of the base to idle respective wheels of the vehicle to prevent escape of the vehicle;
an image acquisition unit installed on the bottom surface of the base and moving to photograph the lower portion of the vehicle; and
an unevenness unit installed within the vehicle exit base and selectively protruding.

2. The smart vehicle checking system for counterterrorism according to claim 1, wherein the vehicle entrance base and the vehicle exit base are foldable upwards so that the base is movable.

3. The smart vehicle checking system for counterterrorism according to claim 1, wherein:
a pair of bollards spaced from each other by a designated interval is installed on each of the vehicle entrance base and the vehicle exit base; and
a laser irradiation unit is combined with one of the pair of bollards installed on the vehicle entrance base to irradiate laser beams recognizable by the vehicle driver between the pair of bollards installed on the vehicle entrance base.

4. The smart vehicle checking system for counterterrorism according to claim 1, wherein an elevating lift configured to raise the front portion of the stopped vehicle so as to prevent escape of the vehicle is installed on the base.

5. The smart vehicle checking system for counterterrorism according to claim 1, wherein the identification unit includes a housing having an iris recognizer and a fingerprint recognizer installed thereon, a controller installed within the housing, and a speaker installed within the housing and supporting voice.

6. The smart vehicle checking system for counterterrorism according to claim 5, wherein a license plate recognition unit to recognize the license plate of the vehicle is installed on the upper surface of the housing.

7. The smart vehicle checking system for counterterrorism according to claim 6, wherein the identification unit further includes a wireless communication unit configured to perform signal transmission/reception with a server having information of wanted vehicles and wanted vehicle drivers stored therein and a control center.

8. The smart vehicle checking system for counterterrorism according to claim 1, wherein the vehicle inside inspection unit includes an X-ray scanner.

9. The smart vehicle checking system for counterterrorism according to claim 1, wherein the vehicle escape prevention unit is configured such that two pairs of rollers corresponding to front wheels and rear wheels of the vehicle are exposed from the upper surface of the base and a brake to selectively prevent free rotation of each of the rollers is installed on each of the rollers.

10. The smart vehicle checking system for counterterrorism according to claim 1, wherein the image acquisition unit includes a CCTV configured to be automatically transferred on the upper surface of the base and moving to photograph the lower surface of the vehicle.

11. The smart vehicle checking system for counterterrorism according to claim 1, wherein:
a plurality of through holes is formed through the vehicle exit base; and
the unevenness unit includes a plate, one side of which is hinged to the inside of the vehicle exit base, a plurality of iron pins protruding from the surface of the plate, and an elevating cylinder to raise the plate so that the iron pins protrude from the through holes.

12. The smart vehicle checking system for counterterrorism according to claim 1, wherein a GPS monitoring unit raised to attach a GPS transmitter to the lower surface of the vehicle is further installed on the base.

13. The smart vehicle checking system for counterterrorism according to claim 1, further comprising protection walls hinged to both side surfaces of the base.

14. The smart vehicle checking system for counterterrorism according to claim 1, further comprising a proximity sensor configured to detect a distance from the vehicle.
